(19) United States
(12) Patent Application Publication
(10) Pub. No.: US 2024/0099490 A1
(43) Pub. Date: Mar. 28, 2024

(54) LOCKER OPENING CONTROL METHODS, STORAGE CONTROL METHODS, USER END, SERVER END, AND INTELLIGENT DELIVERY LOCKER

(71) Applicants: ZHEJIANG KOUBEI NETWORK TECHNOLOGY CO., LTD., Hangzhou, Zhejiang (CN); RAJAX NETWORK TECHNOLOGY (SHANGHAI) CO., LTD., Shanghai (CN)

(72) Inventors: Xu LIU, Shanghai (CN); Yining LU, Shanghai (CN); Kai CHEN, Shanghai (CN); Wei ZHOU, Shanghai (CN)

(21) Appl. No.: 18/256,473

(22) PCT Filed: Feb. 8, 2022
(86) PCT No.: PCT/CN2022/075546

§ 371 Date: Jun. 8, 2023

(30) Foreign Application Priority Data
Dec. 8, 2020 (CN) 202011424073.5
Dec. 8, 2020 (CN) 202110407510.0
Dec. 8, 2020 (CN) 202110410864.0

(51) Int. Cl. A47G 29/14

(52) U.S. Cl. CPC A47G 29/141; A47G 2029/145; A47G 2029/146; A47G 2029/149

(57) ABSTRACT

A locker opening control method, including: sending, based on a triggering operation by a user, a login request carrying a user authorization credential to a first server, so that the first server requests user information from a second server based on the user authorization credential; receiving pickup information corresponding to the user information sent by the first server; displaying, based on the pickup information, a pickup detail page including a locker opening function button; and in response to a triggering operation on the locker opening function button on the pickup detail page by the user, sending a locker opening request to the first server.

### CROSS REFERENCE TO RELATED APPLICATIONS

This application is the national phase of International Application No. PCT/CN2022/075546 filed on Feb. 8, 2022, which claims priority to Chinese Patent Applications No. 202011424073.5, 202110407510.0 and 202110410864.0 filed on Dec. 8, 2020, the entire contents of which are incorporated herein by reference.

### TECHNICAL FIELD

The embodiments of the present disclosure relate to the technical field of intelligent delivery, and in particular to locker opening control methods, storage control methods, a user end, a server end, an intelligent delivery locker and opening methods for an intelligent delivery locker, computing devices and computer storage media.

### BACKGROUND

In the field of e-commerce, the delivery of items (including goods and meals) is very important, especially “last mile” delivery is an end link of the entire delivery process and is also a particularly important part of improving user experience. In order to solve practical problems existing in the “last mile” delivery, intelligent delivery lockers have emerged.

Taking takeout delivery as an example, there are currently many delivery platforms in the market, each of which maintains its own users and delivery personal, and it is necessary to configure its own intelligent delivery lockers in designated places. The delivery personal of respective platforms need to place meals in their respective intelligent delivery lockers when delivering meals, and then users are notified by the delivery personal or the platform to pick up the meals at the corresponding intelligent delivery locker. Taking two delivery platforms A and B as examples, due to the inability of the delivery platform A to obtain information such as users, delivery personal, and orders of the delivery platform B, the delivery platform B cannot share the use of intelligent delivery lockers of the delivery platform A. In prior art, in the “last mile” delivery link, information is not interoperable between different delivery platforms, and delivery resources cannot be shared and integrated, resulting in low delivery efficiency and poor user experience.

Therefore, how to utilize existing information sharing platforms to achieve information exchange and integration of delivery resources and improve user experience of the “last mile” delivery is a technical problem that urgently needs to be solved in the prior art.

### SUMMARY

In view of the above problems, embodiments of the present disclosure are proposed to provide locker opening control methods, a user end, a server end, computing devices and computer storage media that overcomes or at least partially solves the above problems.

According to an aspect of the embodiments of the present disclosure, there is provided a locker opening control method, including: sending, based on a triggering operation by a user, a login request carrying a user authorization credential to a first server, so that the first server requests user information from a second server based on the user authorization credential; receiving pickup information corresponding to the user information sent by the first server; displaying, based on the pickup information, a pickup detail page including a locker opening function button; and in response to a triggering operation on the locker opening function button on the pickup detail page by the user, sending a locker opening request to the first server.

According to another aspect of the embodiments of the present disclosure, there is provided a locker opening control method, including: receiving a login request carrying a user authorization credential; requesting user information from a second server based on the user authorization credential; querying for pickup information corresponding to the user information; and receiving a locker opening request sent based on monitoring of a triggering operation on a locker opening function button on a pickup detail page displayed based on the pickup information by a user, and controlling an intelligent delivery locker to open a container.

According to yet another aspect of the embodiments of the present disclosure, there is provided a user end, including: a login module, configured to send, based on a triggering operation by a user, a login request carrying a user authorization credential to a first server, so that the first server requests user information from a second server based on the user authorization credential; a receiving module, configured to receive pickup information corresponding to the user information sent by the first server; a displaying module, configured to display, based on the pickup information, a pickup detail page including a locker opening function button; and a requesting module, configured to send, in response to a triggering operation on the locker opening function button on the pickup detail page by the user, a locker opening request to the first server.

According to yet another aspect of the embodiments of the present disclosure, there is provided a server, including: a user information obtaining module, configured to receive a login request carrying a user authorization credential, and request user information from a second server based on the user authorization credential; a querying module, configured to query for pickup information corresponding to the user information; and a controlling module, configured to receive a locker opening request sent based on monitoring of a triggering operation on a locker opening function button on a pickup detail page displayed based on the pickup information by a user, and control an intelligent delivery locker to open a container.

According to yet another aspect of the embodiments of the present disclosure, there is provided a computing device, including a processor, a memory, a communication interface and a communication bus. The processor, the memory and the communication interface communicate with each other through the communication bus; the memory is configured to store at least one executable instruction, which causes the processor to perform operations corresponding to the above locker opening control method.

According to yet another aspect of the embodiment of the present disclosure, there is provided a computer storage medium storing at least one executable instruction that causes a processor to perform operations corresponding to the above locker opening control method.

According to the locker opening control methods, the user end, the server end, the computing devices and the computer storage media in the embodiments of the present disclosure, the first server can request the user information from the second server based on the user authorization credential sent by the user end, and obtain the pickup information based on the user information, thereby providing the user end with a one-tap locker opening function for the intelligent delivery locker. In the embodiments of the present disclosure, the first server (corresponding to a certain delivery platform) can provide intelligent delivery locker delivery services to users who do not belong to the delivery platform, achieving the sharing and integration of delivery resources (i.e., intelligent delivery lockers), improving the delivery efficiency of the “last mile” delivery link, and greatly improving the convenience for users to pick up items.

The above description is only an overview of the technical solution of the embodiments of the present disclosure. In order to have a clearer understanding of the technical means of the embodiments of the present disclosure, the technical solution can be implemented according to contents of the specification. In order to make the above and other purposes, features, and advantages of the embodiments of the present disclosure more clear and understandable, the specific implementation of the embodiments of the present disclosure is listed below.

### BRIEF DESCRIPTION OF THE DRAWINGS

By reading the detailed description of the following exemplary embodiments, various other advantages and benefits will become clear to ordinary technical personnel in the art. The accompanying drawings are only intended to illustrate the exemplary embodiments and are not considered as limitations of the embodiments of the present disclosure. Moreover, like parts are denoted by like reference signs throughout the drawings. In the drawings:

FIG. 1 shows a flowchart illustrating a locker opening control method according to an embodiment of the present disclosure;

FIG. 2 shows a flowchart illustrating a locker opening control method according to another embodiment of the present disclosure;

FIG. 3 shows a flowchart illustrating a locker opening control method according to yet another embodiment of the present disclosure;

FIG. 4 shows a flowchart illustrating a locker opening control method according to yet another embodiment of the present disclosure;

FIG. 5 shows a flowchart illustrating storage processing for an in-system order according to an embodiment of the present disclosure;

FIG. 6 shows a flowchart illustrating storage processing for an out-of-system order according to an embodiment of the present disclosure;

FIG. 7 shows a flowchart illustrating pickup processing according to an embodiment of the present disclosure;

FIG. 8 shows a schematic structural diagram illustrating a user end according to an embodiment of the present disclosure;

FIG. 9 shows a schematic structural diagram illustrating a server according to an embodiment of the present disclosure;

FIG. 10 shows a schematic structural diagram illustrating a computing device according to an embodiment of the present disclosure.

### DETAILED DESCRIPTION OF THE EMBODIMENTS

Exemplary embodiments of the present disclosure will be described in more detail below with reference to accompanying drawings. Although exemplary embodiments of the present disclosure are shown in the accompanying drawings, it should be understood that the present disclosure can be implemented in various forms and should not be limited by the embodiments described herein. On the contrary, these embodiments are provided for a more thorough understanding of the present disclosure and to fully convey the scope of the present disclosure to those skilled in the art.

In the solution provided by the embodiments of the present disclosure, intelligent delivery lockers can be shared among delivery platforms, and delivery object from different delivery platforms can place items in the intelligent delivery lockers. The intelligent delivery lockers can provide delivery services to users of other delivery platforms. In the embodiments of the present disclosure, a first server is specifically a server of a delivery platform, and a second server is specifically a server of an open platform. The delivery platform accesses the open platform and supports users to register/login to the delivery platform by using user account information of the open platform. The open platform can be WeChat open platform, Alipay open platform, etc., and is not limited in the present disclosure.

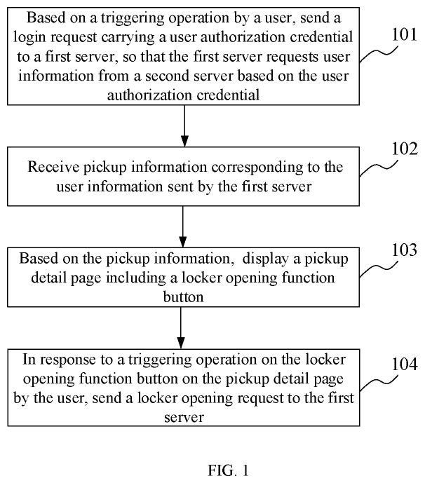

FIG. 1 shows a flowchart of a locker opening control method according to an embodiment of the present disclosure, which is performed by a user end. As shown in FIG. 1, the method includes the following steps.

Step 101, based on a triggering operation by a user, a login request carrying a user authorization credential is sent to a first server, so that the first server requests user information from a second server based on the user authorization credential.

This step is specifically a step in which the user end logs in to the first server based on the triggering operation by the user. The specific process can be as follows: after monitoring the triggering operation by the user, the user end sends the login request carrying the user authorization credential to the first server, and the first server requests user information from the second server based on the user authorization credential. The user authorization credential is obtained by the user after completing a user authorization operation on the user end. Generally, the user end will store the user authorization credential locally on the user end for subsequent login.

The triggering operation by the user can be a code scanning operation by the user. For example, users can use a code scanning function on the user end to perform the code scanning operation, call a local service program embedded in the user end, and the local service program performs step 101 to log in to the first server. The triggering operation by the user can also be an operation of actively starting the local service program by the user. For example, the user can search and start the local service program, and the local service program performs step 101 to log in to the first server.

Step 102, pickup information corresponding to the user information sent by the first server is received.

After the user completes the login, the first server obtains the pickup information based on the user information, generates a pickup detail page, and feeds back the pickup detail page to the user end. In order to facilitate the user to pick up one or more items, a locker opening function button is displayed on the pickup detail page.

Step 103, based on the pickup information, a pickup detail page including a locker opening function button is displayed.

Step 104, in response to a triggering operation on the locker opening function button on the pickup detail page by the user, a locker opening request is sent to the first server.

The user end presents the pickup detail page to the user, and monitors a one-tap locker opening operation initiated by the user on the pickup detail page. For example, the user taps on the locker opening function button to send the locker opening request to the first server, achieving one-tap control of opening an intelligent delivery locker.

Optionally, the pickup information includes one or more of the following information: identification information of the intelligent delivery locker, a number of a container (also referred to as a locker box) storing one or more items to be picked up, location information of the intelligent delivery locker, and order information. Correspondingly, the pickup detail page can display the above pickup information. If the first server finds that a user has multiple items to be picked up placed in multiple locker boxes of the intelligent delivery locker, the pickup detail page displays a list of numbers of the multiple locker boxes, so that the user can select which locker boxes to open simultaneously by operating the locker opening function button.

An application scenario of the above method is described in detail below with an example of an application to an open platform. In this application scenario, the execution subject of the above method is a user end corresponding to an open platform, specifically an applet embedded in the user end, which can be referred to as a delivery service applet.

In the above step 101, the delivery service applet is called based on a code scanning operation by the user. If the user calls the delivery service applet for the first time, the delivery service applet requires the user to perform an authorization operation. After the user confirms the authorization, the delivery service applet obtains a user authorization credential and caches the user authorization credential locally. The delivery service applet sends a login request carrying the user authorization credential to the first server, and the first server requests the second server for user information according to the user authorization credential. The user information can include first user information and second user information, where the first user information is user account information (for example, a mobile phone number of the user) on the first server, and the second user information is user account information on the second server (for example, user open account information on the open platform, hereinafter referred to as Openid). The first server returns login information to the delivery service applet.

In the above step 102, the user performs an operation in the delivery service applet to request to query for pickup information. The first server can query for pickup information corresponding to the user based on the user information, and feed the pickup information back to the delivery service applet.

In the above step 103, the delivery service applet displays a pickup detail page including a locker opening function button based on pickup information.

In the above step 104, the user taps on the locker opening function button in the delivery service applet, and the delivery service applet sends a locker opening request to the first server. The first server controls the intelligent delivery locker to open a container accordingly.

In the above embodiment of the present disclosure, the first server can request the user information from the second server based on the user authorization credential sent by the user end, and the first server can query and obtain pickup information based on the user information, thereby providing the user end with a one-tap locker opening function for the intelligent delivery locker. The first server can provide intelligent delivery locker delivery services to users who do not belong to the delivery platform, which realizes the sharing and integration of delivery resources, improves the delivery efficiency of the “last mile” delivery link, and greatly improves the convenience for users to pick up items.

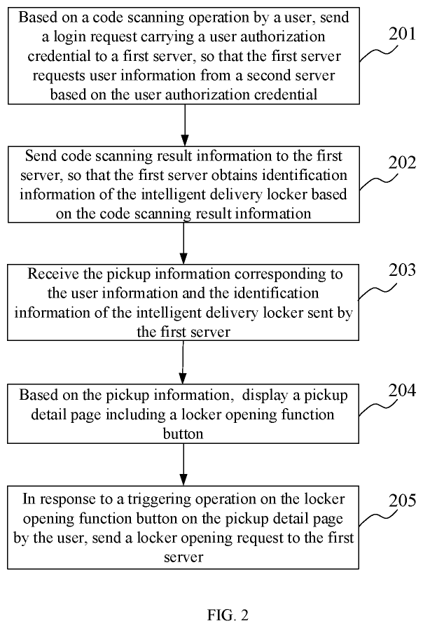

FIG. 2 shows a flowchart of a locker opening control method according to another embodiment of the present disclosure, which is performed by a user end. As shown in FIG. 2, the method includes the following steps.

Step 201, based on a code scanning operation by a user, a login request carrying a user authorization credential is sent to a first server, so that the first server requests user information from a second server based on the user authorization credential.

In this embodiment, the triggering operation by the user can be a code scanning operation by the user. For example, the user can use a scanning function on the user end to perform code scanning operation, and call a local service program embedded in the user end, so that the local service program performs the step 201 to log in to the first server.

In an optional implementation, the intelligent delivery locker provides a two-dimensional code for login/registration. In this way, after arriving at the intelligent delivery locker, the user can start the “scan” function on the user end to scan the two-dimensional code on the intelligent delivery locker and call the delivery service applet. The login request carrying the user authorization credential can be sent to the first server, so that the first server can request second user information and the mobile phone number of the user from the second server, and complete the user login/registration.

Step 202, code scanning result information is sent to the first server, so that the first server obtains identification information of the intelligent delivery locker based on the code scanning result information.

After the local service program is called, the local service program sends the code scanning result information to the first server based on the code scanning operation by the user. The code scanning result information can include information that represents the identification information of the intelligent delivery locker. The first server can obtain the identification information of the intelligent delivery locker based on the code scanning result information, so that the first server can determine which intelligent delivery locker the user requests the pickup from at present.

In an optional implementation, the local service program can analyze the identification information of the intelligent delivery locker locally on the user end and send it to the first server. Specifically, feedback information of the code scanning operation by the user is analyzed to obtain the identification information of the intelligent delivery locker as the code scanning result information.

In another optional implementation, the local service program does not perform local analysis on the user end, but sends feedback information of the code scanning operation by the user to the first server, so that the first server analyzes the feedback information of the code scanning operation by the user and obtains the identification information of the intelligent delivery locker.

The above steps 201 and 202 can be performed sequentially or simultaneously, and the execution order of the two steps is not limited in the present disclosure.

Step 203, the pickup information corresponding to the user information and the identification information of the intelligent delivery locker sent by the first server is received.

After the user completes the login, the first server obtains the user information and the identification information of the intelligent delivery locker, so it can be determined which user requests the pickup from which intelligent delivery locker at present. The first server queries for storage information of the corresponding intelligent delivery locker to determine whether the intelligent delivery locker includes items of the user. If so, the pickup information of the user is obtained based on the storage information.

Step 204, based on the pickup information, a pickup detail page including a locker opening function button is displayed.

Step 205, in response to a triggering operation on the locker opening function button on the pickup detail page by the user, a locker opening request is sent to the first server.

In the above embodiment of the present disclosure, the first server can request the user information from the second server based on the user authorization credential sent by the user end, and the first server can query and obtain the pickup information based on the user information, thereby providing the user end with a one-tap locker opening function for the intelligent delivery locker. The first server can provide intelligent delivery locker delivery services to users who do not belong to the delivery platform, which realizes the sharing and integration of delivery resources, improves the delivery efficiency of the “last mile” delivery link, and greatly improves the convenience for users to pick up items. Further, in this embodiment, based on the code scanning operation by the user, the first server can locate which intelligent delivery locker the user requests the pickup from at present, and directly locate and search for the storage information of the corresponding intelligent delivery locker, without the need for extensive searching, greatly improving processing efficiency.

In another embodiment of the present disclosure, the triggering operation by the user can also be an operation of actively starting the local service program by the user. For example, the user can send a login request carrying the user authorization credential to the first server after searching and starting the local service program on the user end, so that the first server can request user information from the second server based on the user authorization credential. Based on the operation that the user actively starts the local service program, the identification information of the intelligent delivery locker is obtained by using a near field communication technology, and the identification information of the intelligent delivery locker is transmitted to the first server.

Optionally, the near field communication technology can be Bluetooth technology. The intelligent delivery locker is equipped with a Bluetooth module, which can transmit the identification information of the intelligent delivery locker to the user end through Bluetooth. After arriving at the intelligent delivery locker, the user opens the delivery service applet on the user end. The applet starts Bluetooth search, finds the intelligent delivery locker, receives the identification information transmitted by the intelligent delivery locker, and transmits the received identification information of the intelligent delivery locker to the first server.

The subsequent processing process is the same as steps 203 to 205. Based on the near field communication technology, the first server can locate which intelligent delivery locker the user requests the pickup from, directly locate and search for the storage information of the corresponding intelligent delivery locker, without the need for large-scale search, greatly improving processing efficiency.

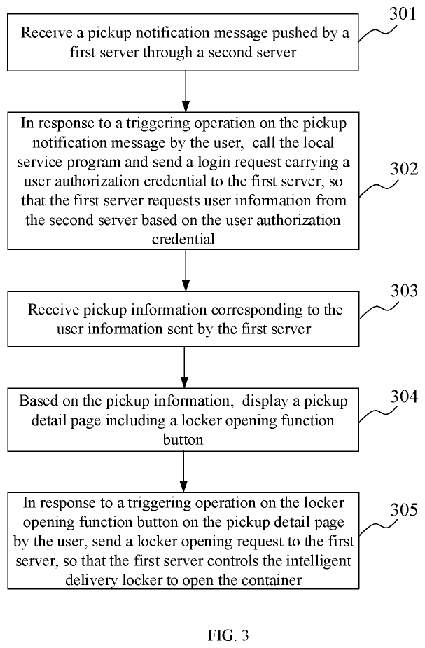

FIG. 3 shows a flowchart of a locker opening control method according to yet another embodiment of the present disclosure, which is performed by a user end. As shown in FIG. 3, the method includes the following steps.

Step 301, a pickup notification message pushed by a first server through a second server is received.

In the embodiment of the present disclosure, the second server has a message reach function, and the message reach is realized by pushing a pickup notification message to the user end of the user. In this way, on the one hand, the user can be notified to pick up one or more items through message reach. On the other hand, one-tap locker opening can be realized based on a triggering operation by the user in response to the reach message. The pickup notification message includes but is not limited to an official account message, a subscription account message, a life account message, a service account messages, etc.

After the delivery object places one or more items corresponding to an order into the intelligent delivery locker, the intelligent delivery locker triggers a callback for closing the door. The first server updates storage information based on the callback message, and records an order status as “entered”. After that, the first server pushes the pickup notification message to the user end of the user through the second server to notify the user of the pickup. Specifically, during the storage of items by the delivery object, the first server will obtain first user information corresponding to the order. The first user information is the user account information on the first server. After the order enters the locker, the first server determines whether there is the first user information corresponding to the order in a database. If yes, the first server further determines whether there is second user information corresponding to the first user information. The second user information is the user account information on the second server. If yes, the first server sends the pickup notification message to the second server and transmits the second user information to the second server, so that the second server can push the pickup notification message to the associated user end by using the second user information.

Optionally, the pickup notification message is a template message that includes not only a text message but also a jump link for calling the local service program. The text message is configured to guide the user to trigger the pickup notification message to open the locker. For example, the text message can be “Your meals/goods have entered the locker, please arrive at * * * location and tap on this message to open the locker. Parameters of the template message include the template jump link, data required to jump to the local service program, etc. The user can tap on the pickup notification message to jump to the local service program, thereby calling the local service program.

Taking the official account message as an example, the first server transmits data to the second server, including Openid (i.e., the second user information), official account ID, authentication information, and message content (including words and jump links). In this way, the second server can determine whether the Openid has followed the official account, and if so, the second server can push the official account message to the user end associated with the Openid.

Step 302, in response to a triggering operation on the pickup notification message by the user, the local service program is called and a login request carrying a user authorization credential is sent to the first server, so that the first server requests user information from the second server based on the user authorization credential.

In this step, the user taps on the pickup notification message on the user end to call the local service program. Then, after the local service program is called, it can be first determined whether there is a user authorization credential cached locally. If yes, a login request carrying the user authorization credential is sent to the first server. If not, an authorization is requested from the user, the user authorization credential is obtained based on an authorization operation by the user and is cached, and then a login request carrying the user authorization credential is sent to the first server. The first server requests user information from the second server based on the user authorization credential. The user information may include first user information and second user information.

Step 303, pickup information corresponding to the user information sent by the first server is received.

Step 304, based on the pickup information, a pickup detail page including a locker opening function button is displayed.

After the user completes the login, based on the triggering operation on the pickup notification message on the user end by the user, the first server directly obtains the pickup information based on the user information, generates the pickup detail page, and feeds back the pickup detail page to the user end. That is, after the user taps on the pickup notification message on the user end and the local service program is called, the local service program directly shows the pickup detail page to the user without additional operation by the user. Optionally, the locker opening function button included on the pickup detail page is a one-tap locker opening control.

Optionally, the pickup information includes one or more of the following information: identification information of the intelligent delivery locker, a number of a container storing one or more items to be picked up, location information of the intelligent delivery locker, and order information. Correspondingly, the pickup detail page can display the above pickup information.

Step 305, in response to a triggering operation on the locker opening function button on the pickup detail page by the user, a locker opening request is sent to the first server, so that the first server controls the intelligent delivery locker to open the container.

Optionally, the user taps on the one-tap locker opening control on the user end, and the local service program sends a locker opening request to the first server. The locker opening request carries the identification information of the intelligent delivery locker and order identification. After receiving the locker opening request, the first server controls the intelligent delivery locker to open the container storing ordered items, updates storage information, and records an order status as “taken out”. A locker opening result is returned to the local service program.

In the above embodiment of the present disclosure, message reach is realized by pushing a pickup notification message from the first server to the user end of the user by using the second server. The user triggers the pickup notification message on the user end, the local service program is called. The local service program logs in to the first server by using the user authorization credential, so that the first server requests the user information from the second server based on user authorization credential to complete login. Next, the local service program presents the pickup detail page generated by the first server based on user information, and further provides the user end with a one-tap locker opening function for the intelligent delivery locker. In this embodiment, the first server can provide intelligent delivery locker delivery services to users who do not belong to the delivery platform, which realizes the sharing and integration of delivery resources, improves the delivery efficiency of the “last mile” delivery link. Moreover, on the user end, the user can be notified to pick up one or more items through message reach, so that the user can receive pickup notification in time. On the other hand, based on the tapping operation by the user in response to the reach message, the local service program is called to directly jump to the pickup detail page. The container can be opened with the one-tap operation on the pickup detail page, so that the user does not need to go to the intelligent delivery locker site for complex code scanning operations to pick up the items, simplifying the user operation mode and greatly improving the convenience for the user to pick up items.

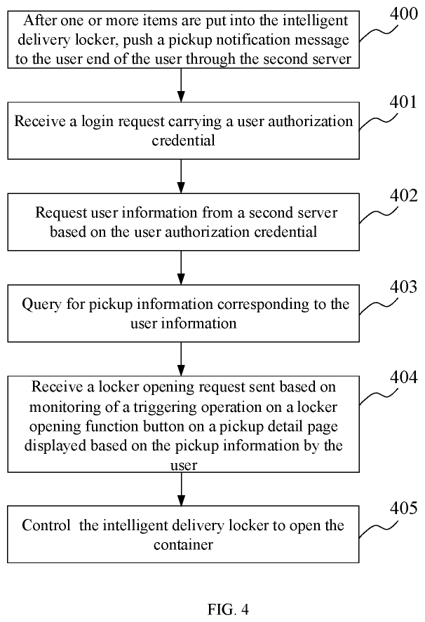

FIG. 4 shows a flowchart of a locker opening control method according to yet another embodiment of the present disclosure, which is performed by a first server. As shown in FIG. 4, the method includes the following steps.

Step 401, a login request carrying a user authorization credential is received.

In this step, after a local service program on a user end is called, the first server receives the login request carrying the user authorization credential sent by the local service program. The local service program can be called based on a code scanning operation by a user on the user end, or it can be called based on an actively starting operation by the user on the user end, or it can be called based on a triggering operation by the user in response to a reach message. For details, please refer to the description of the above embodiments, which is not repeated herein.

Step 402, user information is requested from a second server based on the user authorization credential.

Based on an authorization from the user, the first server can request the user information from the second server. The user information includes first user information and second user information. For example, the first user information is a mobile phone number of the user, and the second user information is Openid. The delivery platform side usually takes the mobile phone number of the user as user account information. The first server can find the user's order for items to be picked up by requesting the mobile phone number of the user and Openid from the second server.

Step 403, pickup information corresponding to the user information is queried for.

The pickup information includes one or more of the following information: identification information of an intelligent delivery locker, a number of a container storing one or more items to be picked up, location information of the intelligent delivery locker, and order information.

If the triggering operation by the user is a code scanning operation by the user, the method further includes: receiving code scanning result information sent after the code scanning operation by the user, and obtaining the identification information of the intelligent delivery locker based on the code scanning result information. Specifically, the identification information of the intelligent delivery locker sent after the code scanning operation by the user is received; or, feedback information of the code scanning operation by the user sent after the code scanning operation by the user is received, the feedback information of the code scanning operation by the user is analyzed to obtain the identification information of the intelligent delivery locker.

If the triggering operation by the user is an operation of actively starting the local service program by the user, the method further includes: receiving the identification information of the intelligent delivery locker obtained through a near field communication technology after the operation of actively starting the local service program by the user. Correspondingly, this step specifically include: querying for the pickup information corresponding to the user information and the identification information of the intelligent delivery locker.

Step 404, a locker opening request sent based on monitoring of a triggering operation on a locker opening function button on a pickup detail page displayed based on the pickup information by the user is received.

Step 405, the intelligent delivery locker is controlled to open the container.

The specific execution process of the above steps 401 to 405 can be referred to the description of the above user end embodiments, and will not be repeated herein.

In another embodiment of the present disclosure, before the step 401, the method further includes: step 400, after one or more items are put into the intelligent delivery locker, pushing a pickup notification message to the user end of the user through the second server.

In order to provide a clearer explanation of the technical solution of the embodiments of the present disclosure, the process of putting items into the locker (storage process) will be introduced in detail below. Orders involved in the items are divided into in-system orders and out-of-system orders.

It should be understood that the in-system orders and the out-of-system orders are distinguished based on business conditions. If the intelligent delivery locker belongs to a delivery platform, orders inside the delivery platform belong to the in-system orders, and orders outside the delivery platform belong to the out-of-system orders. If the intelligent delivery locker does not belong to any delivery platform, all orders entering the locker belong to the out-of-system orders. The technical solution of the present disclosure supports delivery objects from different delivery platforms to place items in the intelligent delivery locker.

For an in-system order: after arriving at the intelligent delivery locker, the delivery object can perform a code scanning operation through a delivery object end (a client used by the delivery object). Based on the code scanning operation by the delivery object, the local service program embedded in the delivery object end can be called. After the local service program is called, it is first determined whether there is a delivery object authorization credential (authorization credential of the delivery object) cached locally. If so, the local service program sends a login request carrying the delivery object authorization credential to the first server. If not, the local service program requests an authorization from the delivery object, obtains and caches the delivery object authorization credential according to an authorization operation by the delivery object, and sends a login request carrying the delivery object authorization credential to the first server. The first server requests delivery object information from the second server based on the delivery object authorization credential, including a delivery object Openid and a mobile phone number of the delivery object. The first server returns login information to the delivery object.

After completing the login, the delivery object operates on a page of the local service program to request to query for order information of an order currently being delivered. The first server responds to the request, queries for the order information of the order currently being delivered by the delivery object based on the delivery object information, generates a storage detail page, and feeds back the storage detail page to the local service program. The delivery object taps on a storage control on the storage detail page, and the first server receives a storage request sent by the delivery object end. The storage request carries the identification information of the intelligent delivery locker and identification of the in-system order. After receiving the storage request, the first server controls the intelligent delivery locker to open the container, stores storage information, and returns a locker opening result to the local service program. The storage information can include the number of the container where the items are stored and order information. Since the order is an in-system order, the first server can obtain the detailed information of the item order and store it in the storage information.

After the delivery object places the items corresponding to the order in the container and closes a door of the container, the intelligent delivery locker triggers a callback for closing the door. The first server updates the storage information based on the callback message, and records an order status as “entered”. The first server queries for the first user information and the second user information corresponding to the in-system order, and determines whether there is the first user information corresponding to the in-system order in a database. If yes, the first server further determines whether there is second user information corresponding to the first user information. If yes, the first server sends the pickup notification message to the second server and transmits the second user information to the second server, so that the second server can push the pickup notification message to the associated user end by using the second user information.

For an out-of-system order: after arriving at the intelligent delivery locker, the delivery object can perform a code scanning operation through a delivery object end (a client used by the delivery object). Based on the code scanning operation by the delivery object, the local service program embedded in the delivery object end can be called. After the local service program is called, it is first determined whether there is a delivery object authorization credential (authorization credential of the delivery object) cached locally. If so, the local service program sends a login request carrying the delivery object authorization credential to the first server. If not, the local service program requests an authorization from the delivery object, obtains and caches the delivery object authorization credential according to an authorization operation by the delivery object, and sends a login request carrying the delivery object authorization credential to the first server. The first server requests delivery object information from the second server based on the delivery object authorization credential, including a delivery object Openid and a mobile phone number of the delivery object. The first server returns login information to the delivery object.

Different from the processing mode of the in-system order, even if the delivery object completes the login, the first server cannot find order information of an order currently being delivered by the delivery object based on the delivery object information. Therefore, for the out-of-system order, the delivery object operates on a page of the local service program and inputs partial information of the first user information. The partial information of the first user information can be a part of a mobile phone number of the user, such as last digits, or a combination of first three digits and last digits. For example, the delivery object can first enter last four digits of the mobile phone number of the user. The first server receives a storage request sent by the delivery object end, which carries the identification information of the intelligent delivery locker and a part of the mobile phone number of the user.

Next, the first server performs verification of the first user information, which can be divided into two cases, taking the first user information being the mobile phone number as an example:

In case (1), if the user once experienced a historical pickup behavior at an intelligent delivery locker corresponding to locker identification, a database corresponding to the intelligent delivery locker of the first server will record the complete mobile phone number of the user. For this case, after receiving last digits of the mobile phone number of the user input by the delivery object, the first server will find one or more user mobile phone numbers with the same last digits recorded in the database corresponding to the intelligent delivery locker. If a matching result is unique, the mobile phone number of the user corresponding to the out-of-system order will be filled up and stored in the storage information.

In practical application scenarios, even in the delivery range of the same intelligent delivery locker, there may be a situation where last digits of mobile phone numbers of different users happen to be the same, that is, the matching result of last digits of the mobile phone number is not unique. For example, if it is queried that two or more user mobile phone numbers with the same last digits are recorded in the database corresponding to the intelligent delivery locker, a request for inputting of first three digits of the mobile phone number of the user is further sent to the delivery object end. After receiving the first three digits of the mobile phone number of the user entered by the delivery object, it is queried for a user mobile phone number with a same combination of first three digits and last digits recorded in the database corresponding to the intelligent delivery locker to obtain a unique matching result. The mobile phone number of the user corresponding to the out-of-system order will be filled up and stored in the storage information.

In case (2): the user has not had any historical pickup behavior at an intelligent delivery locker corresponding to locker identification. For this case, the first server cannot obtain the complete mobile phone number of the user by matching after receiving last digits of the mobile phone number of the user input by the delivery object. The last digits of mobile phone number of the user are stored in the storage information.

After the above verification, the first server returns a locker opening result to the local service program of the delivery object end. After the delivery object places the items corresponding to the order in the container and closes the door of the container, the intelligent delivery locker triggers a callback for closing the door. The first server updates the storage information based on the callback message, and records the order status as “entered”.

Corresponding to the above case (1), the first server can obtain the complete first user information from the database by matching based on partial information of the first user information, and can then obtain the second user information. The first server sends a pickup notification message to the second server, and transmits the second user information to the second server, so that the second server can use the second user information to push the pickup notification message to the associated user end.

Corresponding to the above case (2), the first server cannot obtain the complete user information, so the user cannot be notified to pick up one or more items through message reach. The user can complete the pickup process by code scanning or actively starting the local service program in the future. For example, the above method shown in FIG. 2 can be adopted to perform the pickup process. Since the first server has stored a part of the mobile phone number of the user in the storage information during the storage process, in the pickup process by the user, based on the complete mobile phone number of the user and identification information of the intelligent delivery locker obtained from the code scanning operation by the user or actively starting of the local service program by the user, the first server can determine which intelligent delivery locker the user wants to request the pickup from. The first server queries for storage information of the corresponding intelligent delivery locker to determine whether the storage information of the intelligent delivery locker records partial digits that match the complete mobile phone number of the current pickup user. If so, the pickup information is obtained based on the matched storage information.

In the above embodiment of the present disclosure, the first server can request delivery object information from the second server based on the delivery object authorization credential sent by the delivery object end. Two different ways of items entering a locker are provided for the in-system order and the out-of-system order, so that the intelligent delivery locker is shared among delivery platforms, and the delivery objects from different delivery platforms can put items into the intelligent delivery locker. For an in-system order and an out-of-system order where a user has a historical pickup behavior, the first server can push a pickup notification message to the user end of the user through the second server to achieve message reach. The user can trigger the pickup notification message to achieve one-tap locker opening pickup.

In the embodiment of the present disclosure, delivery object from different delivery platforms can place items in the intelligent delivery locker, and the intelligent delivery locker can provide delivery services to users of other delivery platforms, achieving the sharing and integration of delivery resources, and improving the delivery efficiency of “last mile” delivery link. Moreover, users can open the container with one-tap operation on the pickup detail page, greatly improving the convenience for users to pick up items.

Furthermore, in order to prevent a user from clicking by mistake and causing loss of items when receiving the pickup notification message and performing a remote operation, in the case of notifying the user to pick up items based on message reach, before controlling the intelligent delivery locker to open a container, an embodiment of the present disclosure further include: collecting location information of the user, and matching the location information of the user with location information of the intelligent delivery locker; and/or, obtaining a matching result of near field communication between a user end and the intelligent delivery locker by using a near field communication technology. Controlling the intelligent delivery locker to open the corresponding container according to locker identification corresponding to the one-tap locker opening operation specifically includes: if a matching result of the location information is consistent and/or the matching result of the near field communication is consistent, controlling the intelligent delivery locker to open the corresponding container according to the locker identification corresponding to the one-tap locker opening operation.

An optional implementation is to determine whether the user has arrived at the location of the intelligent delivery locker by using location information. Specifically, the location information of the user is collected by using the local service program and is matched with the location information of the intelligent delivery locker. If the location information of the two indicates that the distance between the user and the intelligent delivery locker is within a preset range, for example, within 5 meters, it is considered that location information of the user matches the location information of the intelligent delivery locker, and the user has already arrived at the location of the intelligent delivery locker. In this case, the intelligent delivery locker can be controlled to open the container.

Another optional implementation is to determine whether the user has arrived at the location of the intelligent delivery locker by using the near field communication technology. Taking Bluetooth technology as an example, the local service program initiates Bluetooth matching on the user end. If the user has already arrived at the location of the intelligent delivery locker, the local service program will obtain a matching result of Bluetooth pairing. In this case, the intelligent delivery locker can be controlled to open the container.

By either of the above implementations, before opening the container, it is first determined whether the user has arrived at the location of the intelligent delivery locker, avoiding the problem of meals/goods loss caused by clicking by mistake to open the container before the user has arrived at the location of the intelligent delivery locker.

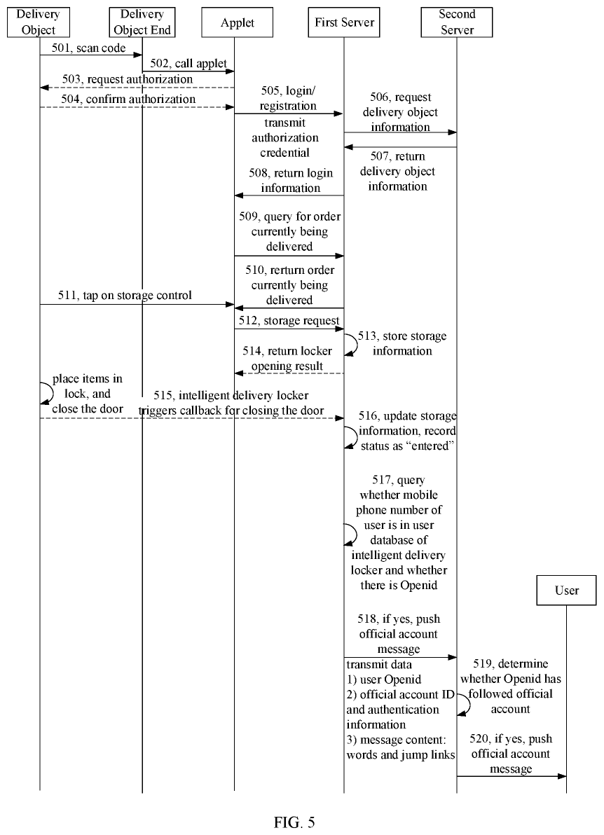

FIG. 5 shows a flowchart illustrating storage processing for an in-system order according to an embodiment of the present disclosure. In this embodiment, through an open platform, a delivery object can call a delivery service applet (hereinafter referred to as an applet) by code scanning to store items in an intelligent delivery locker. As shown in FIG. 5, the method includes the following steps.

From steps 501 to 508, the delivery object performs code scanning and calls the applet after arriving at the intelligent delivery locker to complete login/registration. A first server will obtain user information of the delivery object through a second server, including Openid and a mobile phone number of the delivery object.

From steps 509 to 510, the delivery object performs an operation on a page of the applet to query for order information of an order currently being delivered. The first server finds the order information the order currently being delivered by the delivery object based on the mobile phone number of the delivery object and returns the order information to the applet.

From steps 511 to 512, the delivery object taps on a storage control, and the applet initiates a storage request, which carries identification information of the intelligent delivery locker and identification of the in-system order.

From steps 513 to 514, receiving the storage request, the first server controls the intelligent delivery locker to open a container, stores storage information, and returns a locker opening result to the local service program.

Step 515, after the delivery object puts one or more items into the container and closes the door of the container, the intelligent delivery locker triggers a callback message for closing the door.

Step 516, the first server updates the storage information based on the callback message, and records the order status as “entered”.

Step 517, the first server queries whether a mobile phone number of the user is in a user database of the intelligent delivery locker and whether there is an Openid. If the user has a historical pickup behavior at the intelligent delivery locker, the user database of the intelligent delivery locker will record the mobile phone number and Openid of the user. If the user does not have a historical pickup behavior at the intelligent delivery locker, and messages cannot be pushed to the user (specifically a user end of the user) through an official account in the future, and the user can complete the pickup by other means, such as code scanning.

Step 518, the first server pushes an official account message to the second server, and transmits user Openid, official account ID, authentication information and other data.

Step 519, the second server determines whether the Openid has followed the official account.

Step 520, if yes, the official account message is pushed to the user end associated with the Openid.

In the above embodiment of the present disclosure, the delivery object does not need to provide too much order information when storing items, and delivery objects from any delivery platform can store items in the intelligent delivery locker, thus completing the “last mile” delivery, achieving the sharing and integration of delivery resources, and improving delivery efficiency.

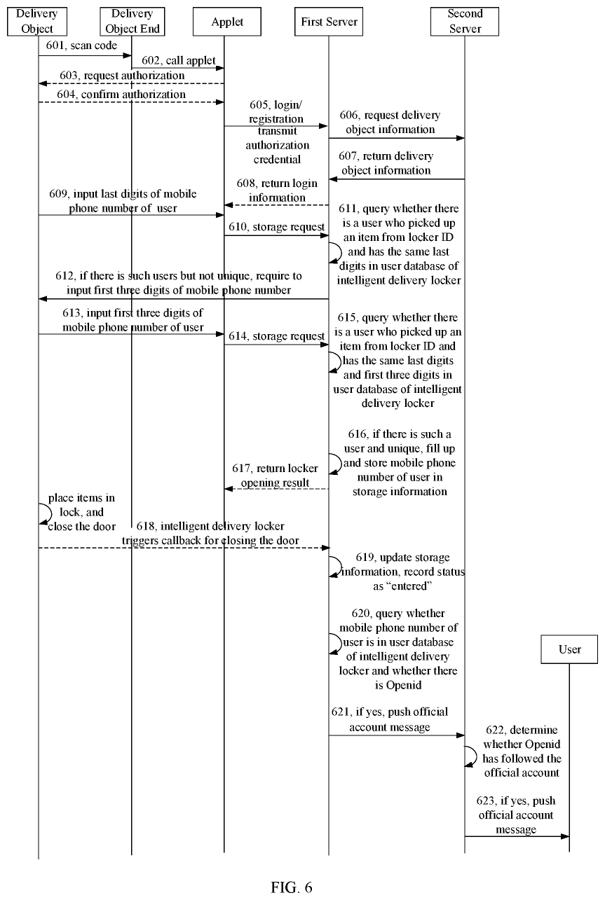

FIG. 6 shows a flowchart illustrating storage processing for an out-of-system order according to an embodiment of the present disclosure. In this embodiment, through an open platform, a delivery object can call a delivery service applet (hereinafter referred to as an applet) by code scanning to store items in an intelligent delivery locker. As shown in FIG. 6, the method includes the following steps.

From steps 601 to 608, the delivery object performs code scanning and calls the applet after arriving at the intelligent delivery locker to complete login/registration. A first server will obtain user information of the delivery object through a second server, including Openid and a mobile phone number of the delivery object.

Step 609, the delivery object performs an operation on a page of the applet and enters last digits of a mobile phone number of the user.

Step 610, the applet initiates a storage request, which carries a locker ID of the intelligent delivery locker and the last digits of the mobile phone number of the user.

Step 611, the first server queries whether there is a user who picked up an item from the intelligent delivery locker corresponding to the locker ID and has the same last digits in the user database of the intelligent delivery locker.

Step 612, if there is such users but not unique, it is required to continue to input first three digits of the mobile phone number of the user.

Step 613, the delivery object inputs the first three digits of the mobile phone number of the user.

Step 614, the storage request is initiated again.

Step 615, the first server queries whether there is a user who picked up an item from the intelligent delivery locker corresponding to the locker ID and has the same last digits and first three digits in the user database of the intelligent delivery locker.

Step 616, if there is such a user and unique, the mobile phone number of the user corresponding to the order is filled up and stored in storage information.

Step 617, the first server controls the intelligent delivery locker to open a container and returns a locker opening result.

Step 618, after the delivery object places one or more items in the container and closes a door of the container, the intelligent delivery locker triggers a callback message for closing the door.

Step 619, the first server updates the storage information based on the callback message, and records an order status as “entered”.

Step 620, the first server queries whether the mobile phone number of the user is in the user database of the intelligent delivery locker and whether there is an Openid.

Step 621, the first server pushes an official account message to the second server, and transmits user Openid, official account ID, authentication information and other data.

Step 622, the second server determines whether the Openid has followed the official account.

Step 623, if yes, the official account message is pushed to the user end associated with the Openid.

In the above embodiment of the present disclosure, when storing items, the delivery object does not need to provide too much order information, but only need to input last digits of the mobile phone number of the user, and dedicated delivery personnel from any delivery platform can store items in the intelligent delivery locker, thus completing the “last mile” delivery, achieving the sharing and integration of delivery resources, and improving delivery efficiency.

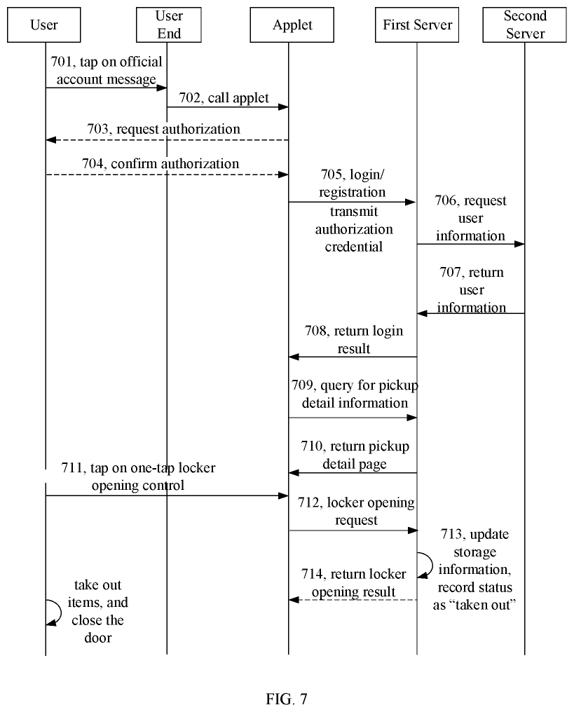

FIG. 7 shows a flowchart illustrating pickup processing according to an embodiment of the present disclosure. In this embodiment, message reach is performed through an open platform, a user can call a delivery service applet (hereinafter referred to as an applet) by tapping on an official account to pick up items in an intelligent delivery locker. As shown in FIG. 7, the method includes the following steps.

From steps 701 to 708, after arriving at the intelligent delivery locker, the user taps on an official account message to pull up the applet and complete login/registration. The first server obtains user information of the user through a second server, including Openid and a mobile phone number of the user.

From steps 709 to 710, the first server directly obtains pickup information based on the mobile phone number of the user, generates a pickup detail page, and returns the pickup detail page to the applet.

From steps 711 to 712, the user taps on a one-tap locker opening control, and the applet initiates a locker opening request, which carries identification information of the intelligent delivery locker and order identification.

From steps 713 to 714, after receiving the locker opening request, the first server controls the intelligent delivery locker to open a container, updates storage information, records a status as “taken out”, and returns a locker opening result to the applet.

In the above embodiment of the present disclosure, when the user picks up items, the applet is pulled by tapping on the official account message, and directly jumps to the pickup detail page. The container can be opened with the one-tap operation on the pickup detail page, so that the user does not need to go to the intelligent delivery locker site for complex code scanning operations to pick up the items, simplifying the user operation mode and greatly improving the convenience for the user to pick up items.

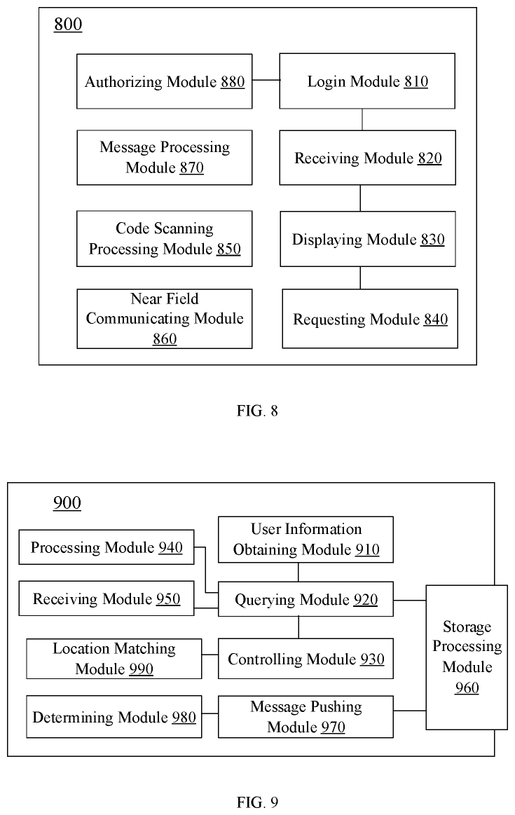

FIG. 8 shows a schematic structural diagram illustrating a user end according to an embodiment of the present disclosure. As shown in FIG. 8, the user end 800 includes a login module 810, a receiving module 820, a displaying module 830 and a requesting module 840.

The Login module 810 is configured to send, based on a triggering operation by a user, a login request carrying a user authorization credential to a first server, so that the first server requests user information from a second server based on the user authorization credential.

The receiving module 820 is configured to receive pickup information corresponding to the user information sent by the first server.

The displaying module 830 is configured to display, based on the pickup information, a pickup detail page including a locker opening function button.

The requesting module 840 is configured to send, in response to a triggering operation on the locker opening function button on the pickup detail page by the user, a locker opening request to the first server.

In an optional implementation, the user end includes a local service program, which is called based on the triggering operation by the user.

In an optional implementation, the pickup information includes one or more of: identification information of an intelligent delivery locker, a number of a container storing one or more items to be picked up, location information of the intelligent delivery locker, and order information.

In an optional implementation, the triggering operation by the user is a code scanning operation by the user, and the user end also includes a code scanning processing module 850, configured to send, based on the code scanning operation by the user, code scanning result information to the first server, so that the first server obtains identification information of an intelligent delivery locker based on the code scanning result information. The receiving module 820 is specifically configured to receive pickup information corresponding to the user information and the identification information of the intelligent delivery locker sent by the first server.

In an optional implementation, the code scanning processing module 850 is specifically configured to analyze feedback information of the code scanning operation by the user to obtain the identification information of the intelligent delivery locker as the code scanning result information.

In an optional implementation, the code scanning processing module 850 is specifically configured to send feedback information of the code scanning operation by the user to the first server, so that the first server analyzes the feedback information of the code scanning operation by the user to obtain the identification information of the intelligent delivery locker.

In an optional implementation, the triggering operation by the user is an operation of actively starting the local service program by the user, and the user end also includes a near field communicating module 860, which is configured to obtain, based on the operation of actively starting the local service program by the user, identification information of an intelligent delivery locker by using a near field communication technology, and transmitting the identification information of the intelligent delivery locker to the first server. The receiving module 820 is specifically configured to receive pickup information corresponding to the user information and the identification information of the intelligent delivery locker sent by the first server.

In an optional implementation, the user end also includes a message processing module 870 configured to receive a pickup notification message pushed by the first server through the second server; where the triggering operation by the user is specifically a triggering operation on the pickup notification message by the user.

In an optional implementation, the pickup notification message includes a jump link for calling a local service program.

In an optional implementation, the user end also includes an authorizing module 880 configured to determine whether there is the user authorization credential cached locally if not, request an authorization from the user, obtaining and caching the user authorization credential based on an authorization operation by the user.

In an optional implementation, the user information includes first user information and second user information; where the first user information is user account information on the first server, and the second user information is user account information on the second server.

In an optional implementation, the message processing module 870 is specifically configured to receive the pickup notification message pushed by the first server through the second server using the second user information.

FIG. 9 shows a schematic structural diagram illustrating a server according to an embodiment of the present disclosure. As shown in FIG. 9, the server 900 includes a user information obtaining module 910, a querying module 920 and a controlling module 930.

The user information obtaining module 910 is configured to receive a login request carrying a user authorization credential, and request user information from a second server based on the user authorization credential. The querying module is configured to query for pickup information corresponding to the user information. The controlling module is configured to receive a locker opening request sent based on monitoring of a triggering operation on a locker opening function button on a pickup detail page displayed based on the pickup information by a user, and control an intelligent delivery locker to open a container.

In an optional implementation, the pickup information includes one or more of: identification information of an intelligent delivery locker, a number of a container storing one or more items to be picked up, location information of the intelligent delivery locker, and order information.

In an optional implementation, the server also includes a processing module 940, configured to receive code scanning result information sent after a code scanning operation by the user, and obtain identification information of the intelligent delivery locker based on the code scanning result information. The querying module 920 is specifically configured to query for pickup information corresponding to the user information and the identification information of the intelligent delivery locker.

In an optional implementation, the processing module 940 is specifically configured to: receive the identification information of the intelligent delivery locker sent after the code scanning operation by the user; or receive feedback information of the code scanning operation by the user sent after the code scanning operation by the user, and analyze the feedback information of the code scanning operation by the user to obtain the identification information of the intelligent delivery locker.

In an optional implementation, the server also includes a receiving module 950, configured to receive identification information of the intelligent delivery locker obtained by using a near field communication technology after an operation of actively starting the local service program by the user. The querying module 920 is specifically configured to query for pickup information corresponding to the user information and the identification information of the intelligent delivery locker.

In an optional implementation, the user information includes a mobile phone number of the user; the server also includes a storage processing module 960, configured to record, during the one or more items are stored, storage information according to a storage request carrying the identification information of the intelligent delivery locker and the partial mobile phone number of the mobile phone number of the user sent by a delivery object end. The querying module 920 is specifically configured to query storage information that matches the user information and the identification information of the intelligent delivery locker, and obtain the pickup information based on the matched storage information.

In an optional implementation, the server further includes a message pushing module 970 configured to push a pickup notification message to the user end of the user through the second server after one or more items are placed in the locker.

In an optional implementation, the pickup notification message includes a jump link for calling the local service program.

In an optional implementation, the user information includes first user information and second user information; the first user information can be user account information on the first server, and the second user information can be user account information on the second server.

In an optional implementation, the server also includes a determining module 980, configured to determine whether the first user information and the second user information are stored in a database.

The message push module 970 is specifically configured to, if it is determined that the first user information and the second user information are stored in the database, send a pickup notification message to the second server and transmit the second user information to the second server, so that the second server can push the pickup notification message to the associated user end by using the second user information.

In an optional implementation, the server also includes a storage processing module, configured to receive a storage request carrying the identification information of the intelligent delivery locker and identification of an in-system order sent by the delivery object end, and query for the first user information and second user information corresponding to the in-system order.

In an optional implementation, the server further includes a storage processing module, configured to receive a storage request carrying the identification information of the intelligent delivery locker and partial information of the first user information sent by the delivery object end, match the partial information of the first user information from the database to obtain the complete first user information, and obtain the second user information.

In an optional implementation, the first user information is a mobile phone number of the user, and the partial information of the first user information is last digits of the mobile phone number of the user, or a combination of first three digits and the last digits of the mobile phone number of the user.

In an optional implementation, the server also includes a location matching module 990, configured to collect location information of the user and match the location information of the user with location information of the intelligent delivery locker; and/or, obtain a matching result of near field communication between the user end and the intelligent delivery locker by using a near field communication technology. The controlling module 930 is specifically configured to control the intelligent delivery locker to open the container if a matching result of the location information is consistent and/or the matching result of the near field communication is consistent.

The description of the above modules refers to the corresponding description in the method embodiments, and will not be repeated herein.

The embodiments of the present disclosure also provide a non-volatile computer storage medium, which stores at least one executable instruction that can perform any of the locker opening control methods in the above method embodiments.

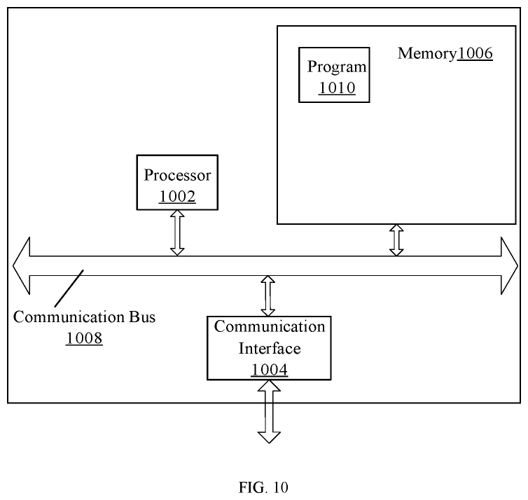

FIG. 10 shows a schematic structural diagram illustrating a computing device according to an embodiment of the present disclosure. The specific implementation of the computing device is not limited in the embodiments of the present disclosure.

As shown in FIG. 10, the computing device may include one or more processors 1002, one or more communication interfaces 1004, one or more memories 1006, and a communication bus 1008. The one or more processors 1002, the one or more communication interfaces 1004, and the one or more memories 1006 communicate with each other through the communication bus 1008. The one or more communication interfaces 1004 are configured to communicate with network elements of other devices such as clients or other servers. The one or more processors 1002 are configured to execute a program 1010, which can specifically perform the relevant steps in the embodiments of the locker opening control methods.

Specifically, the program 1010 may include program codes, which includes computer operating instructions. The one or more processors 1002 may be central processing units (CPUs), application specific integrated circuits (ASICs), or one or more integrated circuits configured to implement embodiments of the present disclosure. The one or more processors included in the computing device may be the same type of processors, such as one or more CPUs; may also be different types of processors, such as one or more CPUs and one or more ASICs. The one or more memories 1006 are configured to store the program 1010. The one or more memories 1006 may include high-speed RAM memories or may also include non-volatile memories, such as at least one disk memory. The program 1010 can be specifically configured to cause the one or more processors 1002 to perform the locker opening control method in any of the above method embodiments. For the specific implementation of each step in the program 1010, please refer to the corresponding steps and units in the above embodiments of the locker opening control method, and will not be repeated herein. It can be clearly understood by those skilled in the art that for the convenience and conciseness of the description, the specific working processes of the devices and modules described above can refer to the corresponding process descriptions in the aforementioned method embodiments, and will not be repeated herein.

The algorithms or displays provided herein are not inherently related to any specific computer, virtual system, or other device. Various universal systems can also be used in conjunction with teaching based on this. According to the above description, the structure required to construct such a system is obvious. In addition, the embodiments of the present disclosure are not specific to any specific programming language. It should be understood that the contents of the embodiments of the present disclosure described herein can be implemented using various programming languages, and the description given to specific languages is for the purpose of disclosing exemplary embodiments of the present disclosure.

The specification provided herein provides a large number of specific details. However, it can be understood that embodiments of the present disclosure can be practiced without these specific details. In some examples, well-known methods, structures, and techniques are not shown in detail to avoid blurring the understanding of this specification. Similarly, in order to simplify the embodiments of the present disclosure and help to understand one or more of the various aspects of the present disclosure, in the above description of the exemplary embodiments of the present disclosure, the various features of the embodiments in the present disclosure are sometimes grouped together into a single embodiment, figure, or description thereof. However, the disclosed method should not be interpreted as reflecting the intention that the claimed embodiments of the present disclosure require more features than those explicitly recited in each claim. More precisely, as reflected in the following claims, aspects of the present disclosure lie in less than all features of the single embodiment disclosed previously. Therefore, the claims following the specific implementation are explicitly incorporated into the specific implementation, where each claim itself serves as a separate embodiment of the present disclosure.

Those skilled in the art can understand that the modules in the device in the embodiment can be adaptively changed and set in one or more devices different from the embodiment. The modules, units, or components in the embodiments can be combined into one module, unit, or component, and in addition, they can be divided into multiple submodules, subunits, or subcomponents. Except that at least some of such features and/or processes or units are mutually exclusive, all features disclosed in this specification (including accompanying claims, abstract and drawings) and all processes or units of any method or device so disclosed can be combined in any combination. Unless otherwise explicitly stated, each feature disclosed in this specification (including accompanying claims, abstract, and drawings) may be replaced by an alternative feature that provides the same, equivalent, or similar purpose. Furthermore, although some embodiments herein include certain features included in other embodiments rather than other features, the combination of features of different embodiments means being within the scope of the present disclosure and forming different embodiments. For example, in the following claims, any one of the claimed embodiments can be used in any combination.

The various component embodiments of the present disclosure can be implemented in hardware, or in software modules running on one or more processors, or in a combination thereof. It should be understood by those skilled in the art that microprocessors or digital signal processors (DSPs) can be used in practice to realize some or all functions of some or all components according to embodiments of the present disclosure. The embodiments of the present disclosure can also be implemented as part or all of the devices or device programs (such as computer programs and computer program products) for performing the methods described herein. The program implementing the embodiments of the present disclosure can be stored on a computer-readable medium or may have the form of one or more signals. Such signals can be downloaded from an internet website, provided on a carrier signal, or in any other form.

It should be noted that the above embodiments illustrate rather than limit the embodiments of the present disclosure, and those skilled in the art can design alternative embodiments without departing from the scope of the appended claims. In the claims, any reference sign between parentheses should not be constructed as a restriction on the claims. The word “comprising” does not exclude the presence of components or steps not listed in the claims. The words “a” or “an” before a component do not exclude the existence of multiple such components. The embodiments of the present disclosure can be implemented by mean of hardware including several different components and by mean of appropriately program computers. In unit claims that list several means, several of these means can be specifically embodied through the same hardware item. The use of words first, second, and third does not indicate any order. These words can be interpreted as names. The steps in the above embodiments should not be understood as limiting the execution order, unless otherwise specified.

What is claimed is:

1. A locker opening control method, comprising:
sending, based on a triggering operation by a user, a login request carrying a user authorization credential to a first server, so that the first server requests user information from a second server based on the user authorization credential;
receiving pickup information corresponding to the user information sent by the first server;
displaying, based on the pickup information, a pickup detail page comprising a locker opening function button; and
in response to a triggering operation on the locker opening function button on the pickup detail page by the user, sending a locker opening request to the first server;
wherein the user information comprises:
first user information, which is user account information of the user on the first server, and
second user information, which is user account information of the user on the second server.

2. The method according to claim 1, wherein the method is performed by a local service program embedded in a user end corresponding to the second server, and the local service program is called based on the triggering operation by the user.

3. (canceled)

4. The method according to claim 1, wherein the triggering operation by the user is a code scanning operation by the user, and the method further comprises:
based on the code scanning operation by the user, sending code scanning result information to the first server, so that the first server obtains identification information of an intelligent delivery locker based on the code scanning result information;
wherein the pickup information corresponding to the user information is pickup information corresponding to the user information and the identification information of the intelligent delivery locker.

5. The method according to claim 4, wherein before sending the code scanning result information to the first server, the method further comprises:
analyzing feedback information of the code scanning operation by the user to obtain the identification information of the intelligent delivery locker as the code scanning result information.

6. The method according to claim 4, wherein sending the code scanning result information to the first server, so that the first server obtains the identification information of the intelligent delivery locker based on the code scanning result information, comprises:
sending feedback information of the code scanning operation by the user to the first server, so that the first server analyzes the feedback information of the code scanning operation by the user to obtain the identification information of the intelligent delivery locker.

7. The method according to claim 2, wherein the triggering operation by the user is an operation of starting the local service program by the user, and the method further comprises:
based on the operation of starting the local service program by the user, obtaining identification information of an intelligent delivery locker by using a near field communication technology, and transmitting the identification information of the intelligent delivery locker to the first server;
wherein the pickup information corresponding to the user information is pickup information corresponding to the user information and the identification information of the intelligent delivery locker.

8. The method according to claim 1, wherein before sending, based on the triggering operation by the user, the login request carrying the user authorization credential to the first server, the method further comprises:
receiving a pickup notification message pushed by the first server through the second server;
wherein the triggering operation by the user is a triggering operation on the pickup notification message by the user.

9-11. (canceled)

12. The method according to claim 1, wherein the first user information is mobile phone number information, wherein,
sending the login request carrying the user authorization credential to the first server, so that the first server requests the user information from the second server based on the user authorization credential, comprises:
sending the login request carrying the user authorization credential to the first server, so that the first server requests a mobile phone number of the user from the second server based on the user authorization credential;
receiving the pickup information corresponding to the user information sent by the first server comprises:
receiving pickup information, corresponding to partial mobile phone number which is received when one or more items are stored and matches with the mobile phone number of the user, sent by the first server; and
the first server is a server of a delivery platform, and stores the pickup information corresponding to the partial mobile phone number of the mobile phone number of the user.

13-14. (canceled)

15. A locker opening control method, applied to a first server of a local service program that accesses an open platform, the method comprising:
receiving a login request carrying a user authorization credential;
requesting user information from a second server based on the user authorization credential;
querying for pickup information corresponding to the user information; and
receiving a locker opening request sent based on monitoring of a triggering operation on a locker opening function button on a pickup detail page displayed based on the pickup information by a user, and controlling an intelligent delivery locker to open a container.

16. The method according to claim 15, wherein the user information comprises first user information which is user account information of the user on the first server, and the user account information of the user on the first server is mobile phone number information, wherein,
requesting the user information from the second server based on the user authorization credential comprises:
requesting a mobile phone number of the user from the second server based on the user authorization credential;
querying for the pickup information corresponding to the user information comprises:
querying for pickup information, corresponding to a partial mobile phone number which is received when one or more items are stored and matches with the mobile phone number of the user; and
the first server is a server of a delivery platform, and stores the pickup information corresponding to the partial mobile phone number of the mobile phone number of the user.

17. The method according to claim 16, further comprising:
receiving code scanning result information sent after a code scanning operation by the user, and obtaining identification information of the intelligent delivery locker based on the code scanning result information;
wherein querying for the pickup information, corresponding to the partial mobile phone number which is received when the one or more items are stored and matches with the mobile phone number of the user, comprises:
querying for pickup information, corresponding to the identification information of the intelligent delivery locker and the partial mobile phone number which is received when the one or more items are stored and matches with the mobile phone number of the user.

18. (canceled)

19. The method according to claim 17 or 18, further comprising:
during the one or more items are stored, recording storage information according to a storage request carrying the identification information of the intelligent delivery locker and the partial mobile phone number sent by a delivery object end;
wherein querying for the pickup information, corresponding to the identification information of the intelligent delivery locker and the partial mobile phone number which is received when the one or more items are stored and matches with the mobile phone number of the user, comprises:
querying for the storage information, which matches with the identification information of the intelligent delivery locker and the partial mobile phone number which is received when the one or more items are stored and matches with the mobile phone number of the user, and obtaining the pickup information based on the storage information.

20-22. (canceled)

23. A storage control method, applied to a first server of an applet for an open platform, the method comprising:
based on a triggering operation by a delivery object, receiving a login request carrying a delivery object authorization credential sent by the applet for the open platform;
requesting delivery object information from a second server based on the delivery object authorization credential, wherein the delivery object information comprises user information of the delivery object on the first server;
querying for order information of an order currently being delivered by the delivery object;
if the order information is found, storing storage information according to a storage request initiated by triggering of a storage control of the order information by the delivery object, and controlling an intelligent delivery locker to open a container.

24. The method according to claim 23, wherein the user information of the delivery object on the first server is a mobile phone number of the delivery object
wherein the delivery object information further comprises user information of the delivery object on the second server.

25-26. (canceled)

27. The method according to claim 23, further comprising:
if the order information is not found, storing storage information according to a storage request initiated by inputting of partial information of first user information by the delivery object, and controlling the intelligent delivery locker to open the container; wherein the first user information is a mobile phone number of a user, and the partial information of the first user information is last digits of the mobile phone number of the user;
wherein the storage request initiated by the inputting of the partial information of the first user information by the delivery object carries the partial information of the first user information and identification information of the intelligent delivery locker.

28. The method according to claim 23, wherein storing the storage information according to the storage request initiated by the triggering of the storage control of the order information by the delivery object, and controlling the intelligent delivery locker to open the container, comprises:
after finding the order information of the order currently being delivered by the delivery object, generating storage detail page information, and feeding back the storage detail page information to a delivery object end;
receiving the storage request initiated by the delivery object end based on the delivery object tapping on the storage control; and
storing the storage information and controlling the intelligent delivery locker to open the container;
wherein the storage request initiated by the triggering of the storage control by the delivery object carries an order identification.

29-30. (canceled)

31. The method according to claim 27, wherein storing the storage information comprises:
querying whether a database of the intelligent delivery locker records an entirety of the first user information;
if a matching result is unique,
filling up the first user information and storing the first user information in the storage information;
if the entirety of the first user information is not obtained by matching,
storing the partial information of the first user information in the storage information.

32. The method according to claim 27, wherein storing the storage information comprises:
querying whether a database of the intelligent delivery locker records an entirety of the mobile phone number of the user;
if a matching result is unique,
filling up the mobile phone number of the user and storing the mobile phone number of the user in the storage information;
if the matching result is not unique,
sending a request for inputting first three digits of the mobile phone number of the user to a delivery object end; after receiving the first three digits of the mobile phone number of the user input by the delivery object, querying for a user mobile phone number with a same combination of first three digits and last digits recorded in the database of the intelligent delivery locker, filling up the mobile phone number of the user, and storing the mobile phone number of the user in the storage information;
if the entirety of the mobile phone number of the user is not obtained by matching,
storing the last digits of the mobile phone number of the user in the storage information.

33-100. (canceled)

101. A computing device, comprising one or more processors, one or more memories, one or more communication interfaces and a communication bus, wherein the one or more processors, the one or more memories and the one or more communication interfaces communicate with each other through the communication bus;
the one or more memory are configured to store at least one executable instruction, which causes the processor to perform operations corresponding to the locker opening control method according to claim 1.

102. (canceled)

103. A computing device, comprising one or more processors, one or more memories, one or more communication interfaces and a communication bus, wherein the one or more processors, the one or more memories and the one or more communication interfaces communicate with each other through the communication bus;
the one or more memory are configured to store at least one executable instruction, which causes the processor to perform operations corresponding to the storage control method according to claim 23.

104-106. (canceled)
